(19) United States
(12) Patent Application Publication
(10) Pub. No.: US 2018/0209085 A1
(43) Pub. Date: Jul. 26, 2018

(54) MAGNETIC VARIABLE-DAMPING VIBRATION REDUCTION CONTROL METHOD OF WASHING MACHINE

(71) Applicant: QINGDAO HAIER DRUM WASHING MACHINE CO., LTD., Qingdao, Shandong (CN)

(72) Inventors: Sheng XU, Qingdao, Shandong (CN); Yanfen LV, Qingdao, Shandong (CN); Qing LIANG, Qingdao, Shandong (CN); Xiuwen PENG, Qingdao, Shandong (CN)

(73) Assignee: QINGDAO HAIER DRUM WASHING MACHINE CO., LTD., Qingdao, Shandong (CN)

(21) Appl. No.: 15/744,468

(22) PCT Filed: Jul. 12, 2016
(86) PCT No.: PCT/CN2016/089730

§ 371 Date: Jan. 12, 2018

(30) Foreign Application Priority Data
Jul. 14, 2015 (CN) 201510413023.X

(51) Int. Cl. D06F 37/20; F16F 9/53

(52) U.S. Cl. CPC D06F 37/203; D06F 37/42; F16F 2230/24; F16F 9/53

(57) ABSTRACT

A magnetic variable-damping vibration reduction control of a washing machine. A variable-damping shock absorber is arranged at the bottom of the outer barrel of a washing machine, one end of the variable-damping shock absorber is connected with the outer drum, while the other end is connected with a housing of the washing machine, and during stages with different rotating speeds, different currents are input into the variable-damping shock absorber, and the variable-damping shock absorber generates corresponding damping forces to reduce vibration, wherein in the vibration reduction process, the amplitude of vibration and the actual rotating speed of the motor are detected in real time, the difference between the actual rotating speed and the target rotating speed is calculated, and the size of the input current is adjusted in real time based on the amplitude of the vibration and the difference between the actual rotating speed and the target rotating speed.

### TECHNICAL FIELD

The present disclosure relates to the field of a washing machine, specifically a vibration reduction control method of a washing machine, and in particular to a magnetic variable-damping vibration reduction control method of the washing machine.

### BACKGROUND ART

In the existing control method, a large current is introduced to the absorber when the motor is at a low speed, a large damping is provided, and during high speed of the motor, no current is introduced and a small damping is provided. Currents of different intensities are introduced to the absorber during different program stages of washing machine, and thus it realizes the variable damping of the whole clothes washing process.

The patent with the application number of 201180022691.X discloses a control method of a magnetorheological fluid shock absorber, only two-stage control is conducted in the dehydration process, V<400 RPM, the current of 1 ampere is introduced, and no current is introduced in other stages.

The patent with the application number of 201110052337.3 discloses a variable-damping shock absorber and a drum washing machine using the shock absorber. The shock absorber includes: a shock absorber barrel body composed of a damping chamber and a cushion chamber, a piston rod inserted into the barrel body, a piston fixedly arranged on the piston rod in the cushion chamber, wherein the cushion chamber is communicated with the outside. The cushion chamber is filled with magnetic fluid, the piston is internally provided with an electromagnet and an orifice which allows the magnetic fluid to pass through, and the electromagnet is connected with a main controller via the wire in the piston rod. The main controller changes the fluidity of the magnetic fluid via controlling the size of the current and utilizing the intensity change of the magnetism of the electromagnet, so as to realize the aim of adjusting the damping in real time. Based on different rotating speeds, four gears are set, which are respectively corresponding to different control current.

However, for each gear time period, the damping is still fixed and unchanged, and the influence of the movement speed of the shock absorber to the damping force is not considered. Through tests, it is detected that the damping force increases along with the increase of the current and the increase of the movement speed of the shock absorber. For example, in the resonance stage, it is originally set that a damping force of 120N can be generated by introducing a current of 1.0 ampere, however, when the eccentricity is larger than the original scalar quantity, the actual rotating speed of the drum is smaller, and after a current of 1.0 ampere is introduced, the output damping force then is less than 120N. Therefore, for each gear time period, the preconceived damping force still cannot be obtained when the input current is set to be fixed and unchanged.

In view of this, the present disclosure is hereby proposed.

### SUMMARY

The objective of the present disclosure is to overcome the shortcomings of the prior art and provide a magnetic variable-damping vibration reduction control method of a washing machine, so as to adjust the size of the input current in real time and obtain the required damping force.

In order to realize the present objective, the present disclosure adopts the following technical solution: a magnetic variable-damping vibration reduction control method of a washing machine is provided, wherein a variable-damping shock absorber is arranged at the bottom of the outer drum of a washing machine, one end of the variable-damping shock absorber is connected with the outer drum, while the other end is connected with a housing of the washing machine. During stages with different rotating speeds, different currents are input into the variable-damping shock absorber, and the variable-damping shock absorber generates corresponding damping forces to reduce vibration. Wherein in the vibration reduction process, the amplitude of vibration and the actual rotating speed of the motor are detected in real time, the difference between the actual rotating speed and the target rotating speed is calculated, and the size of the current is adjusted in real time based on the amplitude of the vibration and the difference between the actual rotating speed and the target rotating speed.

The amplitude of vibration is an amplitude A, the detection of the amplitude of the vibration in real time can be realized through the setting of a sensor unit, and the sensor unit detects the vibration signals in real time and determines the amplitude A.

The control method includes the following steps:

Step 1: the sensor unit detecting the vibration signals, determining the amplitude A; and comparing the amplitude A detected and the preset amplitude A′, if A<A′, maintaining the current state, if A≥A′, then entering the next step.

Step 2: a master control board detecting the real-time rotating speed n of a motor, and simultaneously calling the target rotating speed N set by the program, calculating the speed difference ΔN, and comparing the speed difference ΔN obtained from detection and calculation and the preset speed difference ΔN′, if ΔN<ΔN′, maintaining the current state, if ΔN≥ΔN′, entering the next step.

Step 3: determining a damping force F which is possessed by the variable-damping shock absorber based on the detected amplitude A and the speed difference ΔN obtained through detection and calculation; determining the movement speed V of the variable-damping shock absorber based on the detected amplitude A and the actual speed n detected. And based on the damping force F which is possessed and the movement speed V, determining the current required by the variable-damping shock absorber, and the input current of the variable-damping shock absorber is adjusted.

In step 3, the master control board is internally preset with the one-to-one correspondence relationship between the damping force F which should be possessed by the variable-damping shock absorber and the amplitude A as well as the speed difference ΔN, after the amplitude A and the speed difference ΔN are determined, the damping force F which should be possessed by the corresponding variable-damping shock absorber is acquired.

In step 3, the master control board is internally preset with the corresponding relationship between the movement speed V of the variable-damping shock absorber and the amplitude A as well as the actual speed n: V=2πnAK/60, wherein K is a correction coefficient, preferably, the value of the correction coefficient K is in a range of 0.2-0.5, and after the amplitude A and the actual speed n are determined, the movement speed V of the corresponding variable-damping shock absorber can be obtained through calculation.

In step 3, the master control board is internally preset with the one-to-one correspondence relationship between the current I required by the variable-damping shock absorber and the damping force F which should be possessed by the variable-damping shock absorber as well as the movement speed V. After the damping force F which is possessed by the variable-damping shock absorber as well as the movement speed V are determined, the current I required by the corresponding variable-damping shock absorber is acquired, and the input current of the variable-damping shock absorber is adjusted to I.

In step 1, the preset amplitude A′ are set with four preset ranges comprising 0-20 mm, 0-4 mm, 0-8 mm and 0-2 mm, and preferably 2-10 mm, 1-2 mm, 0.5-1.5 mm and 0.25-1.0 mm, respectively corresponding to the following rotating speed ranges: a low-speed washing stage with a rotating speed of 0-80 RPM, a distribution stage with a rotating speed of 80-150 RPM, an acceleration stage with a rotating speed of 150-400 RPM and a high-speed dehydration stage with a rotating speed of greater than 400 RPM.

In step 3, the value of the preset speed difference ΔN′ is in a range of 0-30 RPM, and preferably 5-10 RPM.

The master control board sets the input current of the variable-damping shock absorber into four gears which respectively correspond to the following four rotating speed ranges: a low-speed washing stage with a rotating speed of 0-80 RPM, a distribution stage with a rotating speed of 80-150 RPM, an acceleration stage with a rotating speed of 150-400 RPM and a high-speed dehydration stage with a rotating speed of greater than 400 RPM, and the input currents corresponding to each gear are respectively 0.1-0.5 ampere, 0.5-1.0 ampere, 1.0-1.5 amperes and 0 ampere.

The master control board sets the input current of the variable-damping shock absorber into four gears which respectively correspond to the following four rotating speed ranges: a low-speed washing stage with a rotating speed of 0-80 RPM, a distribution stage with a rotating speed of 80-150 RPM, an acceleration stage with a rotating speed of 150-400 RPM and a high-speed dehydration stage with a rotating speed of greater than 400 RPM, and the input currents corresponding to each gear are respectively 0.2-0.4 ampere, 0.5-0.6 ampere, 1.2-1.3 amperes and 0 ampere.

After the technical solution of the present disclosure is adopted, the following beneficial effects are brought about:

1. In the control method of the present disclosure, a real-time detection process is added, the input current value is optimized in real time, such that the damping force generated actually approximate the required damping force to the greatest extent, the resonance of the whole system caused by the vibrating parts is avoided while the vibration is weakened to the greatest extent

2. In the control method of the present disclosure, on the basis of determining the amplitude of the damping force by the size of the current, the influence of the size of the motor rotating speed (namely, the movement speed of the shock absorber) on the damping force should be considered more, the whole washing machine can be divided into multiple stages in terms of the rotating speed, in each stage, real-time detection is conducted and the current is finely adjusted, such that the actually generated damping force approximates the required damping force to the greatest extent.

The specific embodiments of the present disclosure will be further described in detail below in combination with the accompanying drawings.

### BRIEF DESCRIPTION OF THE DRAWINGS

FIG. 1 is a flow chart of a control method of a embodiment in the present disclosure;

FIG. 2 is a schematic diagram of segmented control in the embodiment of the present disclosure;

FIG. 3 is a schematic diagram of a connection structure of a washing machine in the embodiment of the present disclosure;

FIG. 4 is a structural schematic diagram of a shock absorber in the embodiment of the present disclosure.

Reference numerals: 1. shell, 2. piston, 3. electromagnet, 4. piston rod, 5. sealing ring, 6. wire, 7. buffer spring, 8. cushion chamber, 9. buffering baffle plate, 10. damping chamber, 11. suspension spring, 22. outer drum, 33. variable-damping shock absorber, 44. housing.

### DETAILED DESCRIPTION OF THE EMBODIMENTS

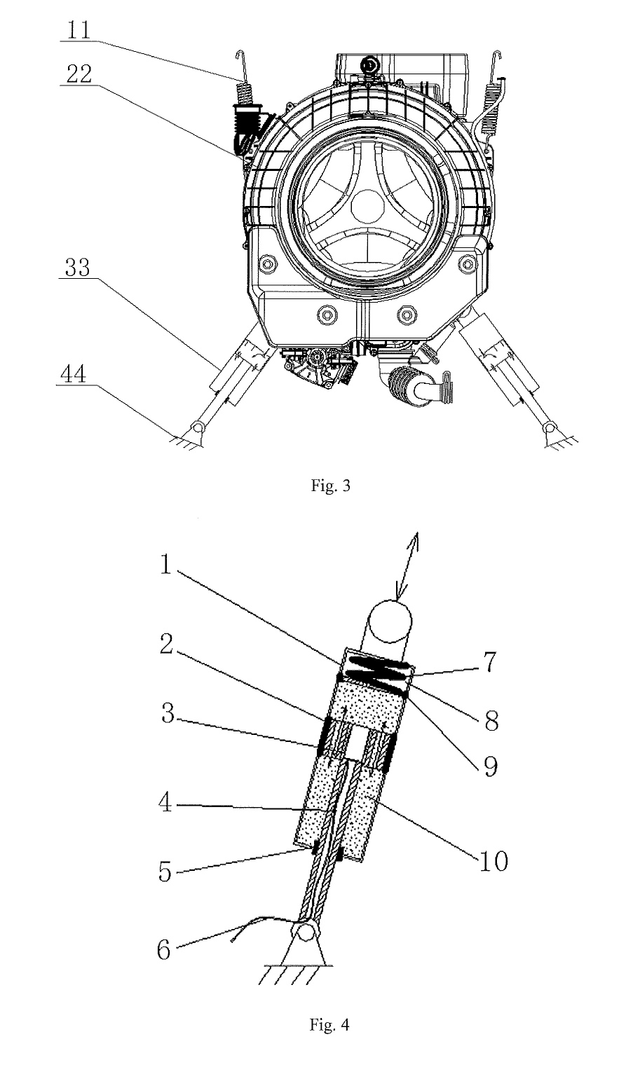

A magnetic variable-damping vibration reduction control method of a washing machine in the present disclosure, as shown in FIG. 3, a variable-damping shock absorber 33 is arranged at the bottom of the outer drum 22 of a washing machine, one end of the variable-damping shock absorber 33 is connected with the outer drum 22, while the other end is connected with a housing 44 of the washing machine. During stages with different rotating speeds, different currents are input into the variable-damping shock absorber, and the variable-damping shock absorber generates corresponding damping forces to reduce vibration, wherein in the vibration reduction process, the amplitude of vibration and the actual rotating speed of the motor are detected in real time, the difference between the actual rotating speed and the target rotating speed is calculated, and the size of the current is adjusted in real time based on the amplitude of the vibration and the difference between the actual rotating speed and the target rotating speed. The upper part of the outer drum 22 is hanged on the housing 44 of the washing machine via a suspension spring 11.

The amplitude of the damping force of the magnetic variable-damping shock absorber is related to the current, and the two are in a direct proportional relationship. Therefore, the size of the current required to be input by the shock absorber is generally determined after the required damping force is determined. However, when the current input by the shock absorber is fixed, sometimes, the generated damping forces are different, as the damping is also related to the movement speed of the shock absorber besides being related to the input current, and the damping force increases along with the increase of the current and the increase of the movement speed of the shock absorber. While the difference between the rotating speed during washing process and that during dehydration process of the washing machine is large, the movement speeds of the shock absorber are greatly different, so it is not accurate to obtain the preconceived damping force only based on the input current. Also, due to such reasons as load eccentricity, there's still a difference between the actual rotating speed of the washing machine and the set rotating speed, which leads to a difference between the actual movement speed of the shock absorber and the preset movement speed. For example, if it is assumed that a damping force of 120N can be generated by introducing a current of 1.0 ampere, however, when the eccentricity is larger than the original scalar quantity, the actual rotating speed of the drum is small, the movement speed of the shock absorber becomes small, and the damping force output when a current of 1.0 ampere is input is less than 120N. Generally, the nominal damping force specification of the variable-damping shock absorber is measured at a linear speed of 0.1 min/s.

The amplitude of the vibration is measured by the amplitude A, the real-time amplitude of vibration can be detected by setting a sensor unit, and the sensor unit detects the vibration signals in real time and determines the amplitude A, or a displacement sensor detects the displacement to acquire the amplitude A. However, the detection methods are not limited to the ones described above, and all the methods which can detect the amplitude in real time can be applied.

### Embodiment 1

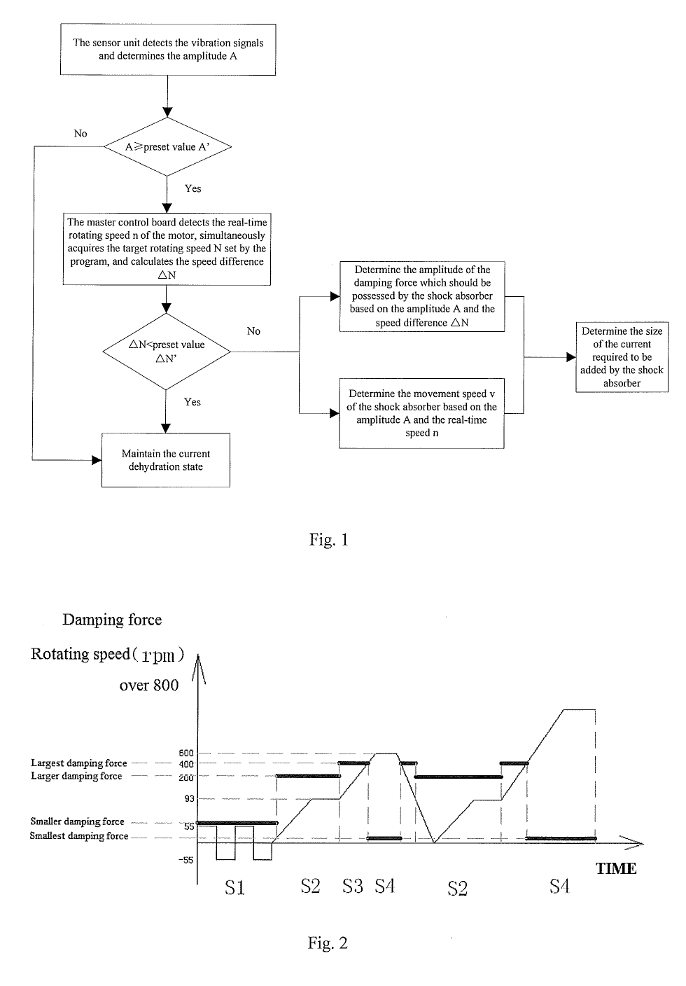

As shown in FIG. 1, in the present embodiment, a real-time detection process is added, the input current value is optimized in real time, such that the damping force generated actually approximate the required damping force to the greatest extent, and the resonance of the whole system caused by the vibrating parts is avoided while the vibration is weakened to the greatest extent, and the control method includes the following steps:

Step 1: the sensor unit detecting the vibration signals, determining the amplitude A, and comparing the detected amplitude A and the preset amplitude A′. If A<A′, maintaining the current state, if A≥A′, entering the next step.

Step 2: a master control board detecting the real-time rotating speed n of a motor, and simultaneously calling the target rotating speed N set by the program, calculating the speed difference ΔN, and comparing the speed difference ΔN obtained from detection and calculation and the preset speed difference ΔN′. If ΔN<ΔN′, maintaining the current state, if ΔN≥ΔN′, entering the next step.

Step 3: a damping force F which should be possessed by the variable-damping shock absorber being determined based on the detected amplitude A and the speed difference ΔN obtained through detection and calculation; the movement speed V of the variable-damping shock absorber being determined based on the detected amplitude A and the detected actual speed n, and based on the lamping force F which should be possessed and the movement speed V, the current I required by the variable-damping shock absorber being determined, and the input current of the variable-damping shock absorber being adjusted.

In step 3, the master control board is internally preset with the one-to-one correspondence relationship between the damping force F which should be possessed by the variable-damping shock absorber and the amplitude A as well as the speed difference ΔN, after the amplitude A and the speed difference ΔN are determined, the damping force F which should be possessed by the corresponding variable-damping shock absorber is acquired. The one-to-one correspondence relationship between the damping force F which should be possessed by the variable-damping shock absorber and the amplitude A as well as the speed difference ΔN is a table correspondence relationship, namely, the amplitude A and the speed difference ΔN correspond to the damping force F which should be possessed by the corresponding variable-damping shock absorber. The correspondence relationship is the correspondence relationship obtained by R&D personnel through numerous experiments or experiences, the correspondence relationship is the correspondence relationship of multiple points which are close but discrete to each other, and if the determined amplitude A and the speed difference ΔN do not have an identical point in the preset correspondence relationship, then close points can be found to determine the damping force F which should be possessed by the corresponding variable-damping shock absorber.

In step 3, the master control board is internally preset with the correspondence relationship between the movement speed V of the variable-damping shock absorber and the amplitude A and the actual speed n: V=2πnAK/60, wherein K is a correction coefficient, preferably, the value of the correction coefficient K is in a range of 0.2-0.5, and after the amplitude A and the actual speed n are determined, the movement speed V of the corresponding variable-damping shock absorber can be obtained through calculation. The shock absorber is connected with the outer drum of the washing machine, and the vibration frequencies of the two are the same. During installation, the shock absorber has a certain included angle with the vertical direction, however, in the movement process of the washing machine, the included angle will be slightly changed, and therefore, the correction coefficient K is introduced. The movement speed V of the shock absorber can be calculated approximately through the following formula: V=KωA=2πfAK=2πnAK/60, wherein w is the angular speed of the rotation of a drum, n is the rotating speed of the drum with the unit of RPM and representing the number of turns that the drum rotates per minute. If the motor is a direct drive motor, the rotating speed of the motor is the same as that of the drum, a reduction gear is arranged between the motor and the drum, the rotating speed of the drum is obtained by multiplying the rotating speed of the motor by the reduction ratio, K is a correction coefficient and preferably, the value of K is in a range of 0.2-0.5, and more preferably 0.3-0.4.

In step 3, the master control board is internally preset with the one-to-one correspondence relationship between the current I required by the variable-damping shock absorber and the damping force F which should be possessed by the variable-damping shock absorber as well as the movement speed V. After the damping force F which should be possessed by the variable-damping shock absorber and the movement speed V are determined, the current I required by the corresponding variable-damping shock absorber is acquired, the input current of the variable-damping shock absorber is adjusted to I. The one-to-one correspondence relationship between the current I required by the variable-damping shock absorber and the damping force F which should be possessed by the variable-damping shock absorber as well as the movement speed V is a table correspondence relationship, namely, a certain damping force F which should be possessed by the variable-damping shock absorber and a certain movement speed V correspond to the current I required by the corresponding variable-damping shock absorber. The correspondence relationship is the correspondence relationship obtained by R&D personnel through numerous experiments or experiences, and the correspondence relationship is the correspondence relationship of multiple points which are close but discrete to each other. If the damping force F which should be possessed by the variable-damping shock absorber and the movement speed V do not have an identical point in the preset correspondence relationship, then close points can be found to determine the damping force F which should be possessed by the corresponding variable-damping shock absorber.

In step 3, the value of the preset speed difference ΔN′ is in a range of 0-30 RPM, and preferably 5-10 RPM.

In step 1, the preset amplitude A′ are set with four preset ranges comprising 0-20 mm, 0-4 mm, 0-8 mm and 0-2 mm, and preferably 2-10 mm, 1-2 mm, 0.5-1.5 mm and 0.25-1.0 mm, respectively corresponding to the following rotating speed ranges: a low-speed washing stage with a rotating speed of 0-80 RPM, a distribution stage with a rotating speed of 80-150 RPM, an acceleration stage with a rotating speed of 150-400 RPM and a high-speed dehydration stage with a rotating speed of greater than 400 RPM.

Through the above control method, whether the current input at the moment can generate the damping force required at the moment can be detected in real time, and the input current can be optimized and adjusted in real time, such that the damping force actually generated can approximate the required damping force to the greatest extent. Meanwhile, in consideration of determining the magnitude of the damping force based on the size of the current, the influence of the rotating speed of the motor (namely, the movement speed of the shock absorber) on the damping force should be considered more.

In the whole clothes washing process, the motion parameters of the washing machine should be detected in real time, an appropriate damping force is input based on the detected motion parameters, and the amplitude of the damping force is controlled via the current value. The control method is not limited by washing stages, as long as the set control parameters are achieved, then corresponding current value can be input. The motion parameters then can be the rotating speed or the feedback current, however, the feedback current signals are intermittent and not continuous, and therefore, the rotating speed is selected as the detection amount.

In actual test, it is found that during dehydration operation, the difference ΔN between the actual rotating speed n and the target rotating speed N of the washing machine is influenced little by the load amount, the difference ΔN is mainly related to the size of eccentricity, the greater the eccentricity is, the smaller the actual rotating speed is, and vice versa. Therefore, the value of eccentricity can be determined by detecting the real-time rotating speed of the washing machine. When the washing machine is in operation, the operation state of the motor will be fed back to the master control board in real time, therefore, the motor can be used as a functional element detecting the rotating speed of the motor. The master control board adjusts the size of the current based on the operating state of the motor, so as to change the magnetic strength of the electromagnet, control the fluidity of the magnetic fluid and realize the adjustment of the damping force of the shock absorber.

### Embodiment 2

In the present embodiment, on the basis of determining the amplitude of the damping force by the size of the current, the influence of the size of the motor rotating speed (namely, the movement speed of the shock absorber) on the damping force is taken into consideration, the optimization of the current makes the actually generated damping force approximate the required damping force to the greatest extent. And the washing machine is divided into different stages based on the rotating speed, and based on segmented control, each working state stage of the segmented control is controlled in real time. During real-time control, the amplitude of the damping force can be determined based on the detected rotating speed difference ΔN of the motor and the amplitude of the vibration, and the size of the current required to be added is determined based on the actual rotating speed. The current is optimized and adjusted in real time.

As shown in FIG. 2, in terms of the working process and rotating speed of the motor of the washing machine, the working states of the washing machine is divided into the following 4 stages, and an optimal current value is set based on empirical values.

S1: a washing stage, during this stage, the rotating speed is relatively low, the rotating speed is preferably 0-80 RPM, and no great amplitude will be generated. A relatively small damping force is applied to the shock absorber, preferably 80-100N, at this time, the current is 0.1-0.5 ampere, and preferably 0.2-0.4 ampere.

S2: a distribution stage, during this stage, the rotating speed is 80-150 RPM, in this stage, washing is completed, and drainage process is also completed. The rotating speed of the inner drum increases to 93 RPM at a certain acceleration, such that the clothes in the washing machine are distributed on the drum wall evenly. At this time, the rotating speed is larger, the assembly inside and outside the drum will generate a smaller amplitude, and the shock absorber needs to generate a larger damping force. The damping force can be set to be 100-150N at this stage based on different washing machines, and the current is 0.5-1.0 ampere, and most preferably 0.6 ampere.

S3: an acceleration stage, during this stage, the rotating speed is 150-400 RPM, the distribution of the washing machine is finished, and the washing machine needs to be operated at a high speed gradually. At this time, the rotating speed is increased, and the clothes in the drum contains a large amount of water which easily generate resonance. The damping force needs to be increased to a maximum value, so as to prevent the outer drum from colliding with the shell. At this stage, the damping force can be set to be in a range of 150-300N. At this time, the current is 1.0-1.5 amperes, and preferably 1.2 amperes.

S4: a high-speed dehydration stage, during this stage, the rotating speed is over 400 RPM, in this stage, the inner drum has been in operation at a higher speed for a certain time, and part of the water contained in the clothes has also been thrown off. Along with the improvement of the rotating speed of the washing machine, the amplitude will decrease gradually, however, the energy of vibration will be increased. Therefore, the connection between the assembly of the inner and outer drums and the housing should be disconnected, so as to reduce the vibration transmission of the assembly of the inner and outer drums to the housing. At this stage, the damping force of the shock absorber can be set to be in a range of 0-60N, and no current is introduced.

During segmented control, a process of real-time detection is added to the method, the input current value is optimized in real time, such that the actually generated damping force approximates the required damping force to the greatest extent. The damping is increased or decreased in a targeted manner during the low-speed operation of the vibration system, the resonance of the vibrating parts is avoided while the vibration is weakened to a great extent. During high-speed operation, the damping of the shock absorber is eliminated, the energy of the vibrating parts is prevented from being transmitted to the housing, and the resonance of the housing is avoided.

A real-time detection process is added in all the above stages, the input current value is optimized in real time, the actually generated damping force approximates the required damping force to the greatest extent, and the control method of real-time optimization includes the following steps:

Step 1: the sensor unit detecting the vibration signals, determining the amplitude A, and comparing the detected amplitude A and the preset amplitude A′, if A<A′, maintaining the current state, if A≥A′, then entering the next step;

Step 2: a master control board detecting the real-time rotating speed n of a motor, and simultaneously calling the target rotating speed N set by the program, calculating the speed difference ΔN, and comparing the speed difference ΔN obtained from detection and calculation and the preset speed difference ΔN′, if ΔN<ΔN′, maintaining the current state, if ΔN≥ΔN′, entering the next step; and

Step 3: a damping force F which should be possessed by the variable-damping shock absorber being determined based on the detected amplitude A and the speed difference ΔN obtained through detection and calculation; the movement speed V of the variable-damping shock absorber being determined based on the detected amplitude A and the detected actual speed n, and based on the lamping force F which should be possessed and the movement speed V, the current required by the variable-damping shock absorber being determined, and the input current of the variable-damping shock absorber being adjusted.

The description of specific details in the above steps is the same as that in embodiment 1.

The master control board sets the input current of the variable-damping shock absorber into four gears which respectively correspond to the following four rotating speed ranges: a low-speed washing stage with a rotating speed of 0-80 RPM, a distribution stage with a rotating speed of 80-150 RPM, an acceleration stage with a rotating speed of 150-400 RPM and a high-speed dehydration stage with a rotating speed of greater than 400 RPM, and the input currents corresponding to each gear are respectively 0.1-0.5 ampere, 0.5-1.0 ampere, 1.0-1.5 amperes and 0 ampere.

Further preferably, the master control board sets the input current of the variable-damping shock absorber into four gears which respectively correspond to the following four rotating speed ranges: a low-speed washing stage with a rotating speed of 0-80 RPM, a distribution stage with a rotating speed of 80-150 RPM, an acceleration stage with a rotating speed of 150-400 RPM and a high-speed dehydration stage with a rotating speed of greater than 400 RPM, and the input currents corresponding to each gear are respectively 0.2-0.4 ampere, 0.5-0.6 ampere, 1.2-1.3 amperes and 0 ampere.

Meanwhile, the master control board records the adjustment process of the input current by the variable-damping shock absorber, and outputs to the client periodically, so as to help the R&D personnel in the research and development of the machine, and meanwhile optimize the optimized value of the input current.

### Embodiment 3

As shown in FIG. 4, the magnetic variable-damping shock absorber of the present embodiment includes such parts as a shell 1, a piston 2 and an electromagnet 3, wherein a damping chamber 10 and a cushion chamber 8 constitute a shock absorber barrel. The cushion chamber 8 is communicated with the outside, and the damping chamber 10 is filled with magnetic fluid. The magnetic fluid is composed of three substances including ferromagnetic solid particles, mother liquid oil and stabilizer. The piston is internally provided with an electromagnet and an orifice which allows the magnetic fluid to flow through, the electromagnet 3 is connected with the master control board via a wire 6 in the piston rod 4, the master control board changes the fluidity of the magnetic fluid through controlling the size of the current and utilizing the intensity change of the magnetism of the electromagnet, so as to realize the aim of adjusting the damping in real time.

In the present embodiment, the master control board is connected with the functional element, the size of the current is correspondingly changed based on the requirement of the functional element. When the master control board changes the current, the magnetism of the electromagnet 3 will be changed, at this time, magnetic control is generated at the position of the orifice, iron molecules (nanoparticles) in the magnetic fluid generate a horizontal particle chain under the effect of the magnetic force, the intensity of the particle chain changes along with the intensity of the magnetic force, the fluidity of the magnetic fluid in the orifice is influenced, and the fluidity of the magnetic fluid in the upper and lower chambers of the damping chamber is hindered. If the magnetic fluid wants to pass through the orifice, it needs to break through the particle chain composed of the iron molecules, so as to form a damping force. When the current becomes large, the magnetism of the electromagnet 3 becomes large, the fluidity of the electromagnet lowers, and the damping force increases; when the current becomes small, the magnetism of the electromagnet becomes small, the fluidity of the magnetic fluid is enhanced, and the damping force decreases. When the electromagnetic force is big enough, the shock absorber can be of a rigid body to completely limit the vibration of the vibrating parts. During high-speed operation, the damping of the shock absorber is eliminated, at this time, the electromagnetic force is small enough, to prevent the energy of the vibrating parts from passing onto the housing, and avoid resonance of the housing. When the damping is increased or decreased in a targeted manner, the resonance of the whole system caused by the vibrating parts can be avoided while vibration is reduced to a great extent.

What is described above is merely preferred embodiments of the present disclosure. It should be noted that, for those of ordinary skill in the art, under the premise of not departing from the present disclosure, various transformations and improvements can still be made, and such transformations and improvements shall also be deemed as falling within the protection scope of the present disclosure.

1. A magnetic variable-damping vibration reduction control method of a washing machine, comprising:
providing a variable-damping shock absorber arranged at a bottom of an outer drum of a washing machine, wherein, one end of the variable-damping shock absorber is connected with the outer drum, another end is connected with a housing of the washing machine, and during stages with different rotating speeds, different currents are input into the variable-damping shock absorber, and the variable-damping shock absorber generates corresponding damping forces to reduce vibration,
in a vibration reduction process, detecting an amplitude of vibration and an actual rotating speed of a motor in real time,
calculating a difference between the actual rotating speed and a target rotating speed, and
adjusting a size of an input current in real time based on the amplitude of vibration and the difference between the actual rotating speed and the target rotating speed.

2. The magnetic variable-damping vibration reduction control method of the washing machine according to claim 1, wherein the amplitude of vibration is an amplitude A,
a sensor unit is set to realize a real-time detection of the amplitude of vibration, and
the sensor unit detects a vibration signal in real time and determines the amplitude A.

3. The magnetic variable-damping vibration reduction control method of the washing machine according to claim 2, comprising following steps:
step 1: the sensor unit detecting the vibration signal, determining the amplitude A,
comparing the amplitude A detected and a preset amplitude A′, if A<A′, maintaining current state, if A≥A′, then entering next step;
step 2: a master control board detecting the actual rotating speed n of the motor in real time, and simultaneously taking a target rotating speed N set by a program, calculating a speed difference ΔN, and comparing the speed difference ΔN obtained from detection and calculation with a preset speed difference ΔN′,
if ΔN<ΔN′, maintaining current state, if ΔN≥ΔN′, entering next step; and
step 3: determining a damping force F which is possessed by the variable-damping shock absorber based on the detected amplitude A and the speed difference ΔN obtained through detection and calculation;
determining a movement speed V of the variable-damping shock absorber based on the amplitude A detected and the actual rotating speed n detected, and
based on the damping force F which is possessed and a movement speed V, determining the current required by the variable-damping shock absorber, and
adjusting the input current of the variable-damping shock absorber.

4. The magnetic variable-damping vibration reduction control method of the washing machine according to claim 3, wherein,
in step 3, the master control board is internally preset with a one-to-one correspondence relationship between the damping force F which is possessed by the variable-damping shock absorber and the amplitude A and the speed difference ΔN,
after the amplitude A and the speed difference ΔN are determined, the damping force F which is possessed by the corresponding variable-damping shock absorber is acquired.

5. The magnetic variable-damping vibration reduction control method of the washing machine according to claim 3, wherein,
in step 3, the master control board is internally preset with a corresponding relationship between the movement speed V of the variable-damping shock absorber and the amplitude A and the actual rotating speed n: V=2πnAK/60, wherein K is a correction coefficient, and
after the amplitude A and the actual rotating speed n are determined, the movement speed V of the corresponding variable-damping shock absorber is obtained through calculation.

6. The magnetic variable-damping vibration reduction control method of the washing machine according to claim 5, wherein a value of the correction coefficient K is in a range of 0.2-0.5.

7. The magnetic variable-damping vibration reduction control method of the washing machine according to claim 3, wherein,
in step 3, the master control board is internally preset with a one-to-one correspondence relationship between the current I required by the variable-damping shock absorber and the damping force F which is possessed by the variable-damping shock absorber; and the movement speed V,
after the damping force F which is possessed by the variable-damping shock absorber as well as the movement speed V are determined, the current I required by the corresponding variable-damping shock absorber is acquired, and the input current of the variable-damping shock absorber is adjusted to I.

8. The magnetic variable-damping vibration reduction control method of the washing machine according to claim 3, wherein,
in step 1, the preset amplitude A′ are set four preset ranges comprising 0-20 mm, 0-4 mm, 0-8 mm and 0-2 mm respectively corresponding to following four rotating speed ranges: a low-speed washing stage with a rotating speed of 0-80 RPM, a distribution stage with a rotating speed of 80-150 RPM, an acceleration stage with a rotating speed of 150-400 RPM and a high-speed dehydration stage with a rotating speed of greater than 400 RPM.

9. The magnetic variable-damping vibration reduction control method of the washing machine according to claim 8, wherein the preset amplitude A′ are set four preset ranges of 2-10 mm, 1-2 mm, 0.5-1.5 mm and 0.25-1.0 mm respectively corresponding to the low-speed washing stage, the distribution stage, the acceleration stage and the high-speed dehydration stage.

10. The magnetic variable-damping vibration reduction control method of the washing machine according to claim 3, wherein in step 3, a value of the preset speed difference ΔN′ is in a range of 0-30 RPM.

11. The magnetic variable-damping vibration reduction control method of the washing machine according to claim 10, wherein a value of the preset speed difference ΔN′ is in a range of 5-10 RPM.

12. The magnetic variable-damping vibration reduction control method of the washing machine according to claim 3, wherein the master control board sets the input current of the variable-damping shock absorber into four gears which respectively correspond to the following four rotating speed ranges: a low-speed washing stage with a rotating speed of 0-80 RPM, a distribution stage with a rotating speed of 80-150 RPM, an acceleration stage with a rotating speed of 150-400 RPM and a high-speed dehydration stage with a rotating speed of greater than 400 RPM, and
the input currents corresponding to gears are respectively 0.1-0.5 ampere, 0.5-1.0 ampere, 1.0-1.5 amperes and 0 ampere.

13. The magnetic variable-damping vibration reduction control method of the washing machine according to claim 12, wherein the master control board sets the input current of the variable-damping shock absorber into four gears which respectively correspond to the following four rotating speed ranges: the low-speed washing stage with a rotating speed of 0-80 RPM, the distribution stage with a rotating speed of 80-150 RPM, the acceleration stage with a rotating speed of 150-400 RPM and the high-speed dehydration stage with a rotating speed of greater than 400 RPM, and
the input currents corresponding to gears are respectively 0.2-0.4 ampere, 0.5-0.6 ampere, 1.2-1.3 amperes and 0 ampere.

14. The magnetic variable-damping vibration reduction control method of the washing machine according to claim 4, wherein the master control board sets the input current of the variable-damping shock absorber into four gears which respectively correspond to the following four rotating speed ranges: a low-speed washing stage with a rotating speed of 0-80 RPM, a distribution stage with a rotating speed of 80-150 RPM, an acceleration stage with a rotating speed of 150-400 RPM and a high-speed dehydration stage with a rotating speed of greater than 400 RPM, and
the input currents corresponding to gears are respectively 0.1-0.5 ampere, 0.5-1.0 ampere, 1.0-1.5 amperes and 0 ampere.

15. The magnetic variable-damping vibration reduction control method of the washing machine according to claim 5, wherein the master control board sets the input current of the variable-damping shock absorber into four gears which respectively correspond to the following four rotating speed ranges: a low-speed washing stage with a rotating speed of 0-80 RPM, a distribution stage with a rotating speed of 80-150 RPM, an acceleration stage with a rotating speed of 150-400 RPM and a high-speed dehydration stage with a rotating speed of greater than 400 RPM, and
the input currents corresponding to gears are respectively 0.1-0.5 ampere, 0.5-1.0 ampere, 1.0-1.5 amperes and 0 ampere.
